(19) United States
(12) Patent Application Publication
(10) Pub. No.: US 2026/0358990 A1
(43) Pub. Date: Nov. 12, 2026

(54) Control Panel with Multiview Multimedia Windows

(71) Applicant: Jason Patrick Gilbert, Minnetonka, MN (US)

(72) Inventor: Jason Patrick Gilbert, Minnetonka, MN (US)

(21) Appl. No.: 18/638,645

(22) Filed: Apr. 17, 2024

Related U.S. Application Data
(60) Provisional application No. 63/459,708, filed on Apr. 17, 2023.

(51) Int. Cl. G06F 3/14

(52) U.S. Cl. CPC G06F 3/14

(57) ABSTRACT

This invention discloses a novel way of switching, programming, and controlling one or multiple viewing windows on a display screen. There are many screen orientations shown which contain control buttons and viewing windows. The control buttons are used to program the multimedia displayed in one or more viewing windows. The viewing windows can resize to different screen sizes and can react to changes in time or from multiple users programming what the viewing windows display. The main benefit of this invention is to be able to easily customize and program lists of multimedia and use one or many of the lists for switching content in one or many viewing windows.

### CROSS-REFERENCE TO RELATED APPLICATIONS

This application claims the benefit of U.S. Provisional Patent Application No. 63/459,708, filed on Apr. 17, 2023, entitled “Virtual Switchboard Exchange with Television Remote Control and Electronic Program Guide and Multimedia Viewing Windows with Control Button Keypad for a Computer Display Screen Graphical User Interface,” the entire contents of which are hereby incorporated by reference.

### BACKGROUND OF THE INVENTION

The novel invention described herein is related to the field of graphical user interfaces. There are two distinct aspects which both relate to each other. First are the control buttons and second is the viewing windows. It incorporates many elements of prior art. The control buttons are related to control panels, button keypads, icon taskbars, electronic program guides, and related inventions. The viewing windows are related to computer display screens, televisions, video games, virtual reality, movies, and methods of viewing multimedia on a display screen. Some recent prior art which enabled this invention to develop is related to improvements in performance of central processing units CPUs and graphics processing units GPUs. These improvements in computers coupled with the small form factor of smart phones enable mobility in computing. Other related fields include cloud computing, distributed computing, and edge computing, smart TVs, smart remote controls, touch screens, streaming video, highspeed broadband internet, wireless 5G radio, fiber optics, wireless transmission of data via satellite uplink, and many forms of what is known as high tech such as mobile apps, computer applications, cellular connectivity, broadcast television, wireless communication, etc.

### BRIEF SUMMARY OF THE INVENTION

This invention claims to improve on the prior art by enabling a new way to switch multimedia and program viewing windows using an intuitive graphical user interface which can be used on any display screen. The main problems in the current state of the art are an inability to connect any type of multimedia to any type of display screen. For example, currently there is no good solution to send and receive emails on a television, or watch a movie on a video game, or video conference without setup difficulties. There are many problems which prevent interoperability between phones, tablets, computers, TVs, and smart glasses. Furthermore, the myriad of content to display on these screens is formatted for one type of display screen. This invention will enable all multimedia to be viewed on any display screen regardless of screen size, operating system, hardware, or software and from any location. This invention will also lead to increased data throughput of the internet backbone leading to AI smart cities and autonomous vehicles. Computers and TVs have seen little change since the 1990s and this invention aims to make phones, computers, and TVs obsolete by combining all multimedia into one easy to use graphical user interface which works on all display screens. In the future all telephone numbers and voicemail boxes will be replaced with a more advanced audio video system of communication between two or more people. The drawings herein depict the plurality of designs for a graphical user interface on a display screen in the optimized form for controlling, switching, programming, viewing, sharing, and more, live linear television. The current state of prior art falls short of achieving the customization of controller buttons and screen configurations described herein. Unlike physical control buttons with fixed position and function, virtual control buttons can be programmed to move and change function. Computer displays and smart TV screens can move icons around to enable an operator to select a program. Some systems may use a taskbar, favorites bar, tabs, and more to allow the user to customize the icons or controls of their applications. Claim 1 involves the controls interface novel improvement described. Claim 2 involves the viewing window novel improvement described. Some of the controls described directly interface with the viewing windows; however, these controls are not limited in scope to the viewing windows herein. Also, the viewing windows directly interface with some of the control buttons; however, these viewing windows are not limited in scope to the control buttons herein. It should be noted all the icons displayed herein are for illustration and may change in the future. The icons indicate the meaning of the function of the buttons but the function is more important for the purposes of the invention than how the individual icons look. Most of the horizontal configurations are shown with the controls on the top but it works equally the same with the controls on the bottom. The icons are all custom made but not limited only to the ones shown herein. Also, many of the icons in the drawing are simply the logos for the channel identifier buttons which represent a specific channel. Also, there is an image for the channel logo and one for the episode airing live. The station logo is more consistent while the episode now airing image changes when the episode changes which is commonly every 30 minutes. Another standard is for an episode to run every 60 minutes on the top or half of every hour. Another feature which is shown herein and is common in computers is the two-state icon or double click. The two-state icon is useful here to allow for more information before using the double click to confirm selection and the double click prevents accidental button selection which is especially useful in a touch screen environment where accidental button engagement may be more likely. Also, the viewing windows are programmed to automatically adjust to the maximum size available.

### BRIEF DESCRIPTION OF THE SEVERAL VIEWS OF THE DRAWING

FIG. 1A shows the main controls on the top, the channel scrolling controls on the side, the favorites bar on the bottom, and a single viewing window in the center in the horizontal orientation.

FIG. 1B shows the main controls on the top, the channel scrolling controls on the side, the favorites bar on the side, and a single viewing window in the center in the vertical orientation.

FIG. 2A shows the split screen controls on the top, the channel scrolling controls on the side, the favorites bar on the bottom, and a single viewing window in the center in the horizontal orientation.

FIG. 2B shows the split screen controls on the top, the channel scrolling controls on the side, the favorites bar on the side, and a single viewing window in the center in the vertical orientation.

FIG. 3A shows the previous channels controls on the bottom and four channel identifier buttons with four viewing windows in the center in the horizontal orientation.

FIG. 3B shows the previous channels controls on the bottom and four channel identifier buttons with four viewing windows in the center in the vertical orientation.

FIG. 4A shows the favorites channels controls on the bottom and six channel identifier buttons with six viewing windows in the center in the horizontal orientation.

FIG. 4B shows the favorites channels controls on the bottom and four channel identifier buttons with four viewing windows in the center in the vertical orientation.

FIG. 5A shows the channel scroller controls on the top and twelve channel identifier buttons with twelve viewing windows in the center in the horizontal orientation.

FIG. 5B shows the channel scroller controls on the top and six channel identifier buttons with twelve viewing windows in the center in the vertical orientation.

FIG. 6A shows the main controls on the top and six channel identifier buttons with twenty-four viewing windows in the center in the horizontal orientation.

FIG. 6B shows the main controls on the top and four channel identifier buttons with twenty-four viewing windows in the center in the vertical orientation.

FIG. 7A shows the main controls on the top and the twenty-four list selector buttons in the center in the horizontal orientation.

FIG. 7B shows the main controls on the top and the twenty-four list selector buttons in the center in the vertical orientation.

FIG. 8A shows the main controls on the top, the time changer controls on the left, and the electronic program guide buttons in the center in the horizontal orientation.

FIG. 8B shows the main controls on the top, the time changer controls on the top, and the electronic program guide buttons in the center in the vertical orientation.

### DETAILED DESCRIPTION OF THE INVENTION

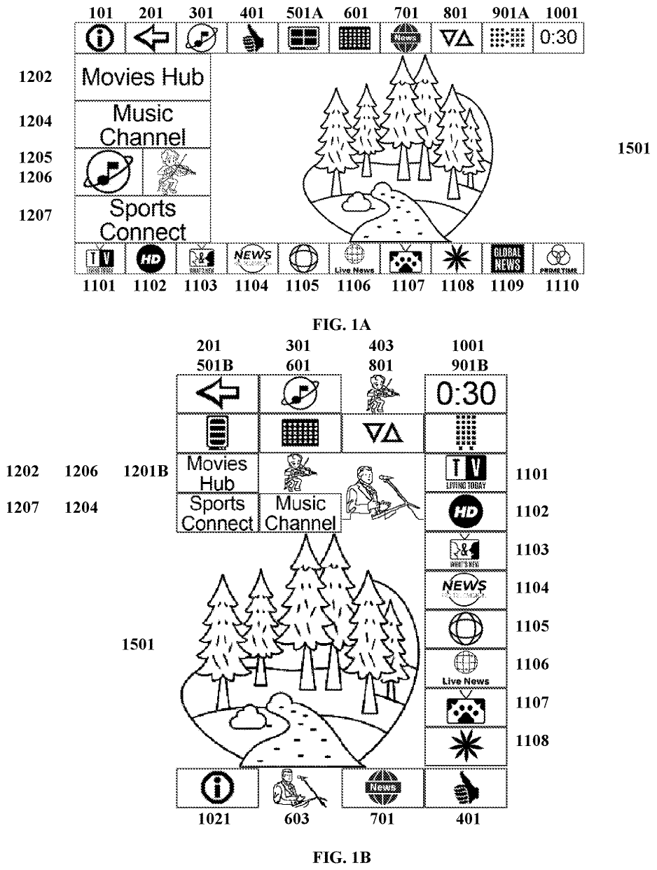

FIG. 1A is an example embodiment of the invention which shows a graphical user interface for customizing a control panel of buttons and controlling a viewing window 1501. The viewing window can display any content from videos, messages, websites, video games, books, images, etc. The viewing windows are not limited to only television programs. The control panel buttons are used to program the viewing windows and have many other functions as well. A button 101 is used to bring up an information window. This closes the current media element in the viewing window and displays a text description about the media in the viewing window. This is common for an info or description button to accompany a media program. The invention includes any form or text such as a news ticker. A button 201 is used to bring up a previous channel menu bar. The previous channel bar is useful to go back in history to connect to channels used in the past. A button 301 is the current channel selected from a scroll of channels. As a user presses a channel up button 1202 or channel down button 1207 the current channel button changes. Scrolling through channel lineups is very common as a television function. A button 401 is used to bring up a favorites bar. Similar to the previous channel history bar, the favorites bar can be programmed to any channel the user wants. There can be multiple favorites lists also. This enables the user to choose from multiple favorites lists from friends, family, celebrities, trending, sports, movies, video games, etc. and any possible list imaginable. A button 501A brings up the split screen button bar. Split screens as useful to enable more than one viewing window to be shown at a time. Televisions had picture in picture in the past but is less common today. Computers have the ability to display multiple viewing windows but the user has to manually configure and arrange them on the screen. Also, when the computer is shut down the viewing window configurations are lost. Herein the user can customize the split screen viewing windows and they can easily be switched and programmed for easy access. Also, this invention is not limited to the split screen orientations seen herein and it is possible for the user to change the sizes, orientations and even shapes of the viewing windows. The optimized versions are shown. A button 601 closes the viewing window to bring up the calendar. For television this is called the electronic program guide EPG. The calendar is useful when the program listing is scheduled by a broadcasting network. This invention is not limited to only the TV EPG and any conceivable calendar can be used including customized schedules the user programs. The user can enter text and time slots for appointments for example. Another case may be to pull up a schedule from a coworker or share schedules with friends. A button 701 is the previous channel. TV remote controls often have a previous channel button. This is useful because when a user switches the content in the viewing window, they may need to quickly switch back to what they were viewing previously. A button 801 brings up the channel changer bar. Scrolling through a list of programmed channel lineups is common and usually channels are given channel numbers users can remember. For example, they like channel number fifty-three or they can scroll through many different lists of channels. The main benefit herein is the ability to have many preprogrammed lists including the premium tv package but also, a video game list, movie list, favorites list, history list, friends list, etc. There are many more types of content lists the user can scroll through. A button 901A closes the current viewing window and brings up the channel selector buttons. Since there is the possibility for multiple channel lists and multiple channels in each list, it is needed for the ability to choose specific channels from within a list. Also, there is the ability to switch between lists. Also, there is the ability to customize the channel lineup or program your own list. For instance, it is common for the television lineup to be in a programmed list with assigned station numbers for the user to scroll through. Maybe there could be an assigned channel number the user wants to change so they can customize the channel lineup order they scroll through. Also, there may be channels in the lineup which the user does not like and so there needs to be an option to remove certain channels from the list. There are endless possibilities of programming and customizing the lists for the channel lineups. One example could be the news station is channel one, the newspaper reading window is channel two, the stock market graphs are channel three, the video conferencing window is channel four, etc. Here the user can combine multiple media types. Another example could be video games, cartoons, image, homework assignment, etc. Currently smart televisions do not allow for some of the other media content to be easily displayed and switched to like this invention enables. A button 1204 is the current channel button and has the same function of the information button 101. The user can click the current channel button to close the viewing window and display information text about the description of what the current channel is. A button 1205 is another current channel button and has the same function as button 301. Here the user may be scrolling through a channel list and they can select the current channel to add to a different list or to display on one of the viewing windows. An element 1206 can be a button or a viewing window. If it is a button, it displays the program currently on the time slot. If it is a viewing window, it displays the actual program. The button image will change when the time reaches the next program on the program schedule. This is common for programs to be scheduled in thirty minute or one hour time slots. Buttons 1101, 1102, 1103, 1104, 1105, 1105, 1106, 1107, 1108, 1109, 1110 make up a favorites bar. Here the user can save channels they frequently use on their favorites bar. Again, the favorites bar can be switched between any number of different favorites lists. There are endless arrangements of lists which can be customized and the favorites bar here allows the user to easily access the channels on the list. Furthermore, the favorites bar here is displayed on the bottom of the viewing window and the control buttons on the top of the viewing window and the channel scroller buttons on the left of the viewing window. These can be moved in case the user like the scroll buttons on the right or the control bar on the bottom and the favorites bar on the top. Also, each bar can be turned off which enables a larger viewing window by hiding any of the control buttons.

FIG. 1B shows a similar embodiment of FIG. 1A but is in the vertical orientation. While many display screens such as TVs or computers use the horizontal screen, modern handheld devices often display content in the vertical orientation. There needs to be a similar interface in the vertical orientation. Maybe there can be other screen sizes as well in different shapes from a rectangle and changing the button configurations to fit the different shape screens will be necessary. Buttons not described above are described below. An element 403 is similar to element 1206 which can be a button or a viewing window for current channel. As the user scrolls through the channel list the image on the button or the content in the viewing window changes to display the current program in the time slot. A button 1001 closes the viewing window and brings up the account information. Very common in computer applications is an account page which usually contains billing and payment information. The button is displaying :30 which indicates the user has thirty minutes of viewing credits. Viewing credits may be used for viewing premium content and will count down to zero as the premium content is watched. When the credits reach zero the viewing window will close and open the credit payment screen. The user will then need to open the account info screen to add more credits ort money to their account. The buttons for adding credits are not shown herein but include features such as adding time credits or to change the credits you pay to watch add free. This was developed to allow for elimination of a subscription form of television to a pay-as-you go or pay-per-view ability. It is possible that with a full subscription you won't see the credits anymore. The drawings for the novel login and payment screens are not shown herein because the scope of the invention focuses on the control buttons for viewing windows. A button 501B is the same as button 501A except the image has changes for the vertical split screen controls. Having split screen in vertical orientation is just as important as the horizontal orientation. Similarly, a button 901B is the same as button 901A but the image is for the vertical orientation. This button will bring up the list selector screen displayed in the vertical orientation. Next the channel scroller buttons like described in the horizontal orientation are buttons, 1202, 1206, 1207, and 1204. Buttons 1202 and 1207 are the channel scroller buttons so the user can scroll up or down from the current channel list. Element 1206 is a button or viewing window for the current channel and will change as the user scrolls through the channel list. Button 1204 display the channel name of the current channel and brings up the information screen about the current channel. A viewing window 1201B can display the previous channel. This allows the user to see what was on another channel or the previous channel while they scroll through the channel list to find another channel. Like the horizontal, buttons 1101, 1102, 1103, 1104, 1105, 1106, 1107, and 1108 can be for a favorites bar. The user can customize any channel and save it here for easy access. The favorites bar can also scroll through any of the numerous possible lists described herein. Element 603 is the button or viewing window for previous channel. Once two channels have been chosen this can display the previous channel program as an image or the media content. This is useful to continue watching the previous channel while viewing another media window or making a new selection from any of the other control button screens in the viewing window for example. Also, the main controls bar of the horizontal orientation in FIG. 1A is in one row whereas the main controls for the vertical orientation in FIG. 1B are split into three rows two on the top and one on the bottom. This means two additional elements totaling twelve elements can be added which is why there are elements 403 and 603 in FIG. 1B not shown in FIG. 1A which has just ten buttons without space for elements 403 and 603 in the single main controls bar. Also, the two top rows can be moved to the bottom with the single bottom row moved to the top. Furthermore, the favorites bar on the right can be moved to the left and the channel scrolling buttons on the left can be mirrored on the right. Some of these and many other embodiments are present in the invention but are not shown herein.

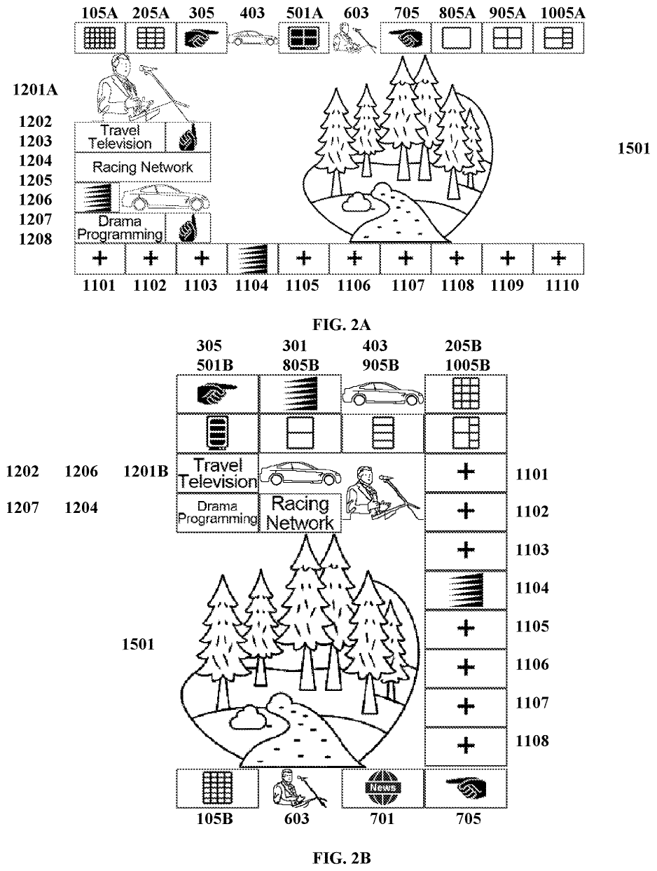

FIG. 2A shows another embodiment of the invention. Herein there is shown the split screen buttons bar. A button 105A brings up the twenty-four viewing windows screen. A button 205A brings up the twelve viewing windows screen. Button 305 turns the element 403 on or off. This is useful because sometimes someone may want to display the media content in a viewing window by turning it on or they may just want to display the image of the program on a button by turning it off. Button 501A toggles from the main controls bar shown in FIG. 1A and the split screens controls bar shown in FIG. 2A. A nice feature is the split screen controls bar toggle button stays in the same place whether the split screen controls are on as in FIG. 2A or off as in FIG. 1A. Element 603 is either a button displaying the image of the previous channel or the media viewing window display the previous channel. A button 705 is similar to button 305 and toggles the previous channel to be the media window or the image of the previous channel program. If the program is scheduled and the time changes to become a new program for example at the top of the hour either the image will change to the image of the new program or the media window will begin displaying the new program. A button 805A brings up the single viewing window screen as is shown in viewing window 1501. A button 905A brings the four viewing windows screen into the viewing window. A button 1005A is for turning the six viewing windows screen on or off. The side controls are for the channel scroller buttons and can be displayed on the left as shown or the right not shown. Here viewing window 1201A is for displaying the previous channel. This allows the user to scroll through other channel lineups while still watching the previous channel. Button 1202 is the channel scroll up button and display the text of the channel name. A button 1203 turns the viewing window 1201A on or off in case a user needs the previous channel viewing window on or off. Button 1204 displays the text of current channel name and when selected brings up the information description in the viewing window. Button 1205 displays the logo of the current channel and if selected can allow the user to add the current channel to any of their lists. Element 1206 displays either the image of the current program on the current channel and gets updated as the time changes to a new program image or displays the viewing window of the current program. As the user scrolls through the channel list the element 1206 changes to display the current channel. Button 1207 displays the text of the channel down on the list and when selected scrolls the channel list down. A button 1208 turns the element 1206 from the program image or the viewing window on or off. Next the favorites bar has changed from FIG. 1A. Here we see plus sign images on the buttons indicating the slot is open and able to be programmed with any channel. Button 1104 now has been programmed with the same icon as the current channel from button 1205. This means the user has now added the current channel to the favorites bar for this particular list. Herein, if the user wanted to switch the viewing window 1501 to the current channel on the scroller or the favorites bar they could select either button 1205 or 1104 and the media content in viewing window 1501 would change to the media content on the channel programmed for the image of buttons 1205 or 1104. Also, for all of the split screen buttons, once selected, if the viewing window is showing something other than the split screen selected, the control buttons and or viewing windows will close and the new split screen selected will now be in the viewing windows. If the split screen button selected is already in the viewing window, then it will close the split screen selected and the previous viewing window which was displayed will be shown in the viewing window.

FIG. 2B is another embodiment of the invention. Similar to FIG. 1B, FIG. 2B is the same as FIG. 2A but optimized for the horizontal orientation. Button 305 toggles the element 403 from program image to program media content. Button 301 is the current program image and when selected can be added to any list. A button 205B brings up the twelve viewing windows split screen and is similar to button 205A but for the vertical orientation. A button 501B toggles between the split screen control buttons and the main controls buttons and is similar to button 501A. Also, it maintains its relative position on the control panel whether the split screen control buttons are on or off. A button 805B turns on or off the single or dual screen viewing windows split screen. Since much media content is viewed in the horizontal position, the horizontal orientation of FIG. 2B has enough space to display two viewing windows unlike the horizontal viewing window of button 805A which is a single horizontal viewing window. Media content that is optimized for vertical viewing such as cell phone videos can be displayed in a single vertical viewing window for example. A button 905B brings up the four viewing windows split screen similar to button 905A. A button 1005B brings up the six split screens viewing windows similar to button 1005A. Buttons 1202, 1207, and 1204 are the same as FIG. 1B and are used to scroll through the channel lists displaying the text of the name of the channel. Elements 1206 and 1201B are for the current and previous channels to display either the now airing program image or the actual program media content. Buttons 1101, 1102, 1103, 1104, 1105, 1106, 1107, and 1108 are the same as FIG. 2A and show how the current channel of buttons 301 and 1204 and element 1206 is added to the favorites list in slot four of button 1104. A button 105B turns on or off the twenty-four viewing windows split screen similar to button 105A. Element 603 is the previous channel program image or media content. Button 701 is the previous channel logo image. Button 705 turns on or off the image or media content of element 603.

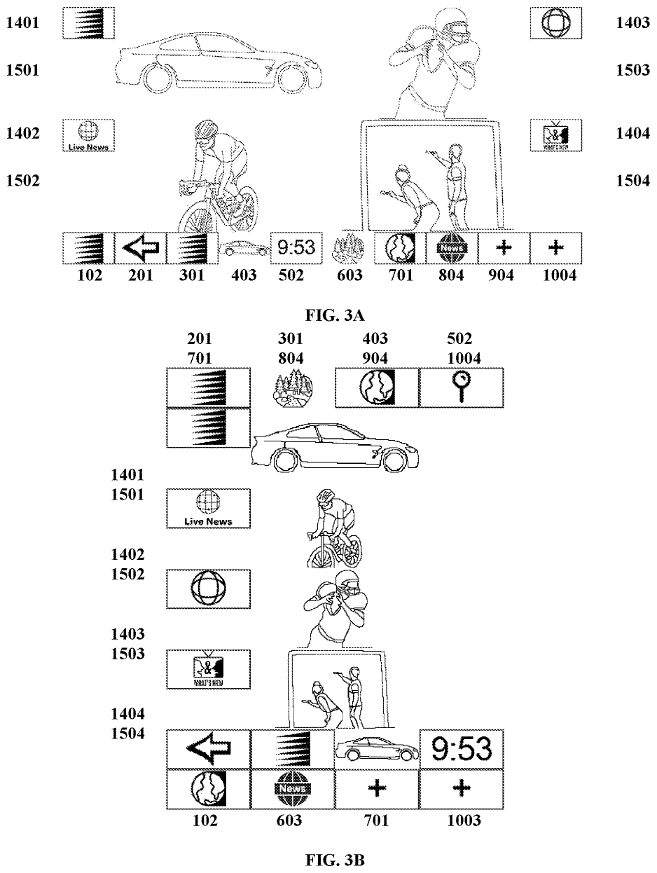

FIG. 3A is another embodiment of the same invention. Herein the main controls bar is now on the bottom and the side buttons for channel scrolling and the favorites bar are turned off which is different from FIG. 1A and FIG. 2A. This is useful because hiding some of the controls allows for the viewing window to increase in size. The user can easily turn the hidden controls back on and change the orientation of the control buttons at any time by a few simple control buttons. A button 1401 is the channel identifier button for viewing window 1501. This embodiment now has the four viewing windows split screen turned on done from button 905A of FIG. 2A. Furthermore, the media content of viewing window one has changed from the user selecting either button 1205 or 1104 from FIG. 2A. Another feature is by adding the channel from button 301 to a button 102. Button 102 is the selector for viewing window one. Also, by selecting button 1401 or 102 will first dim the control buttons to make the viewing windows easier to watch. Once the control buttons are dimmed, selecting button 102 will bring up the full screen mode closing all the control buttons and enabling a more seamless viewing experience. There are many more features of button 102 and this is one of the most powerful buttons in the invention as it is the main control for viewing window one. A button 1402 and a viewing window 1502 are for viewing window two. It is beneficial to have a channel identifier logo for each viewing window. The channel identifier also has other functions such as the user clicks button 1402 and now enter full screen for viewing window two. After closing full screen which is only displaying viewing window two, the screen returns to FIG. 3A back to the four screen multiview viewing windows shown herein. Many of the full screen embodiments are not shown because they do not contain the control buttons. This invention covers the future scenario when many of the buttons can be hidden and voice commands or hand gestures could replace the controls. These scenarios are still in development as there is a significant need right now for the control buttons described herein. A button 1403 and a viewing window 1503 are for viewing window three. A button 1404 and a viewing window 1504 are for viewing window four. These buttons and viewing windows are very similar and can be easily programmed to a different media content or channel and can be easily turned on to a single viewing window in full screen mode. Also not shown in this embodiment are the controls for volume such as volume up or down and mute. Each viewing window has independent volume controls enabling all or some of the viewing windows to be muted or have different volume levels. There are other ways to change the media content in the viewing windows as well. Also, herein the previous channel bar is turned on with button 102 which maintains its position from the main controls screen. A button 502 displays the current time and has some other features including going back to favorite channel. Element 603 and button 701 are for previous channel and since viewing window one has been changed to a new channel from FIG. 1A and FIG. 2A the channel is now what used to be in viewing window one. This is very common to have a previous channel in television but this invention is a more advanced and new way to display previous channels. A button 804 is for second last previous channel showing the channel logo which used to be in previous channel button 701 from FIG. 1A. A button 904 is third previous channel which is a plus sign because there is no channel programmed on it yet. Users can manually add a channel to this slot like in the favorites bar or it will automatically add the channel from button 804 once a new channel is selected for buttons 1401 or 102 for viewing window one; and, the channel logo from button 701 will move to button 804. It is very useful to automatically save the history of previous channels for a user to go back to and this invention saves more than the last four channels in the history list which can be scrolled through as one of the many programmable lists to select channels from. A button 1004 is the fourth previous channel which is also a plus sign representing an open slot. If a user selects a channel which is on the history list for viewing window one the channel will be removed from the list and the next higher up previous channel will move to the next lower previous channel or the slot will be left open with the plus sign. Also note that button 301 and element 403 can change independent of viewing window one. These are for the channel scroller to move through different windows while the viewing window one 1501 is programmed to stay on the channel it is programmed. Furthermore, not shown herein is a button to unlock one, any, or all of the viewing windows so they will not display what they are programmed to display by the channel selector buttons 1401, 1402, 1403, or 1404 but rather can scroll with the channel scroller buttons just like the traditional television remote of flipping through channels. If the button is selected to lock them back then the current channel from the channel scroller will no longer be displayed in the respective viewing window and the viewing window will go back to displaying what it is programmed with on the channel indicator. Also, since there are a plurality of programmable lists herein, it is another feature to change the viewing windows based on the different lists. For example, say you have a news list, a video game list, a books list, etc. you can change the media content in the viewing windows by simply scrolling through the lists so; for example, viewing windows 1501, 1502, 1503, and 1504 may display the top four news channels, then the top four video games, then the top four books to read, etc. This is why the lists are so powerful because they are completely customizable and can contain any type of multimedia. Maybe you want news on window one, video game on window two, books, on window three, etc.

FIG. 3B is another embodiment in the vertical orientation similar to FIG. 3A. Button 201 turns on or off the previous channel buttons bar. Buttons 701, 703, 904, and 1004 are the last four previous channels. A button 1003 brings up a search box for the user to search for a channel or multimedia content.

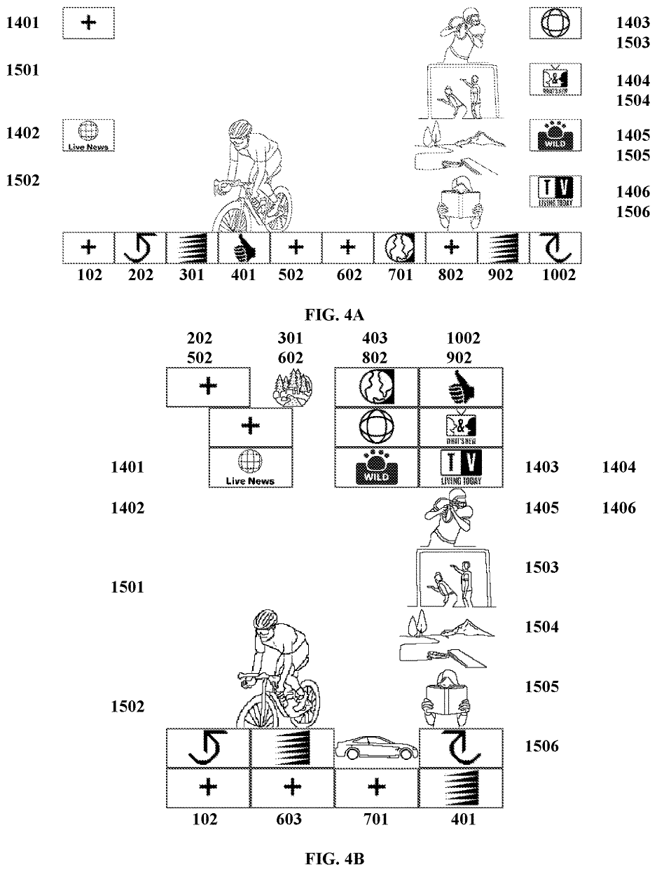

FIG. 4A is another embodiment of the invention. Here the controls are showing the favorites buttons which are turned on or off by button 401 which maintains its position from FIG. 1A. Similarly, button 301 for current channel and button 701 for previous channel maintain the position in most control bars because current channel and previous channel need to be accessed without any extra difficulty. A button 202 scrolls through the favorites list. A button 502 is slot one of the favorites list. A button 602 is slot two of the favorites list. A button 802 is slot three of the favorites list. A button 902 is slot four of the favorites list. As in FIG. 2A favorite channel slot four is programmed with a channel logo. Again, this is only one possible list and there may be multiple favorites list along with multiple user profiles for example. Buttons 1401 and 102 are now unprogrammed as represented by the plus sign. Since these identify the channel programmed for viewing window one there is no media content in viewing window one 1501. It is needed to be able to turn off a viewing window. This can be done without affecting the other viewing windows or to leave it open to program with a new channel later. Here the six viewing window split screen is turned on by button 1005A from FIG. 2A. A button 1405 and a viewing window 1505 are for viewing window five and a button 1406 and a viewing window 1506 are for viewing window six. There may be a plurality of viewing window configurations but shown here are larger viewing windows one 1501 and two 1502; and smaller viewing windows three 1503, four 1504, five 1505, and six 1506.

FIG. 4B is another embodiment similar to FIG. 4A. To maximize the size of the viewing windows in the vertical orientation, the channel identifier buttons 1401, 1402, 1403, 1404, 1405, and 1406 are placed either above or below the viewing windows shown here above. The channel identifier buttons read left to right whereas the viewing windows read top to bottom. Here the six viewing window split screen is turned on by button 1005B from FIG. 2B.

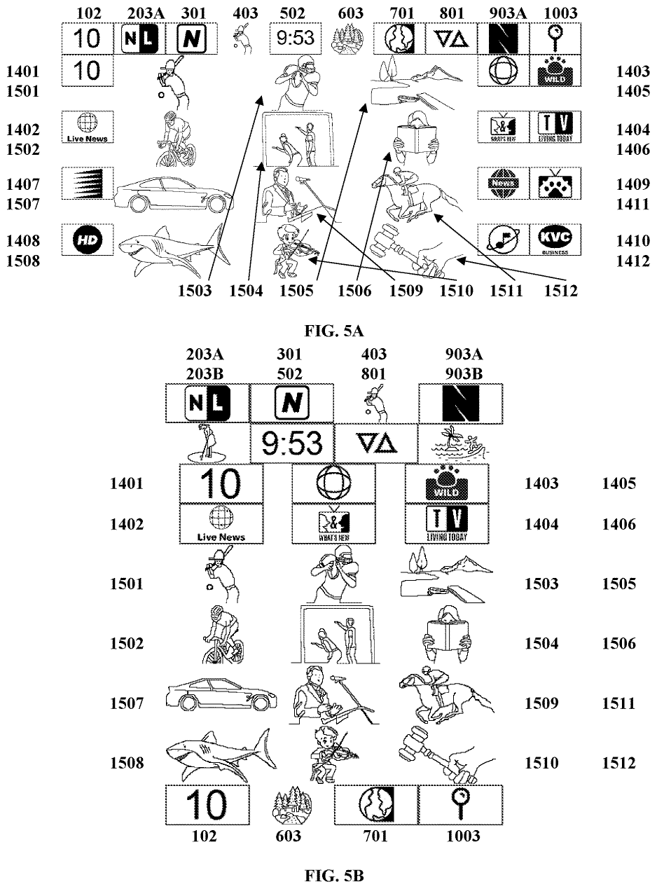

FIG. 5A is another embodiment showing the twelve viewing windows split screen turned on or off by button 205A in FIG. 2A. Viewing window one is now unlocked to be able to change with the channel scroller similar to flipping through channels on a television remote. Buttons 102 and 1401 display the channel number shown as channel ten. The channel number changes along with the media content in viewing window one 1501 as the channel is scrolled using a button 203A for channel down similar to button 1207 in FIG. 1A and FIG. 2A or using a button 903A for channel up similar to button 1202 in FIG. 1A and FIG. 2A. The logo for the channel down is shown on the channel down scroll button 203A and the logo for the channel up is shown on the channel up button 903A. Again, the channel scroller buttons can be used to scroll through a plurality of preprogrammed lists. Button 801 is used to turn the channel changer buttons on or off and maintains its position from the main controls screen of FIG. 1A. The other buttons of the channel changer bar have been mentioned such as current channel 301 and current channel program 403 and previous channel 701 and previous channel program 603. Button 502 is the current time and can be programmed to go back to the current channel after scrolling or back to the favorite channel. This is useful because it can reset the channel scroller back to a defined channel after scrolling away from it. For example, button 502 is programmed as channel five then the channel is scrolled up to channel thirty-five then the user can simply return the scroller to channel five by selecting button 502. Button 1003 can be used to search for a channel if scrolling through the lists is too difficult to find the channel needed. Adding more channel identifier buttons and viewing windows is a button 1407 and a viewing window 1507 for viewing window seven, a button 1408 and a viewing window 1508 for viewing window eight, a button 1409 and a viewing window 1509 for viewing window nine, a button 1410 and a viewing window 1510 for viewing window ten, a button 1411 and a viewing window 1511 for viewing window eleven, and a button 1412 and a viewing window 1512 for viewing window twelve. Again, each window can be independently scrolled through a list, muted or changed volume, turned on to full screen, etc.

FIG. 5B is another embodiment similar to FIG. 5A showing the twelve viewing windows split screen turned on or off by button 205B in FIG. 2B. Button 203A is scroll channel down. Button 301 is current channel. Element 403 is current channel current program image or media content. Button 903A is scroll channel up. An element 203B is channel down program image or media content. Button 502 is current time which can change the scroller back to main channel or favorite channel. Button 801 toggles the channel scroller buttons on or off and maintains its position from the main control bar of FIG. 1B. An element 903B is channel down program image or media content. Buttons 1401 and 102 show the channel number as the channel scroller buttons 203A or 903A scroll through the channel lineup. Herein the elements 203B and 903B can be added because the vertical orientation has space for two more slots. These are useful because the program image or media content can be viewed from the channel before and after the current channel on the scrolling list. Also, in order to save space for maximizing the twelve viewing windows only six viewing window channel identifier buttons can fit. There is another button not shown herein which switches the channel identifiers from the top six to the bottom six. This works as follows. The first scenario is the top six viewing windows are button 1401 for viewing window 1501, button 1402 for viewing window 1502, button 1403 for viewing window 1503, button 1404 for viewing window 1504, button 1405 for viewing window 1505, and button 1406 for viewing window 1506. The button to switch to the bottom six windows can be pressed for the second scenario of button 1401 for viewing window 1507, button 1402 for viewing window 1508, button 1403 for viewing window 1509, button 1404 for viewing window 1510, button 1405 for viewing window 1511, and button 1406 for viewing window 1512. As stated herein these six buttons can be above the viewing windows as shown or below just as the top two main control rows can be on the top with the bottom row main controls as shown or on the two rows on the bottom with the single row on the top not shown herein. It is very useful to have the channel scroller buttons on the bottom of the screen in the vertical orientation not shown herein when using a handheld device because your left thumb easily presses the channel down button 203A and your right thumb easily presses the channel up button 903A. Furthermore, since viewing window one 1501 is unlocked the media content changes with the channel scroll buttons. The media content will rapidly change as the user scrolls through the channel list. The unlocked channel scrolling is not limited to viewing window one 1501. Any viewing window can be scrolled through any conceivable list. For example, viewing window six 1506 can be a list of all your books, or viewing window ten 1510 can be a list of all your music stations or songs playlists. Also scrolling is not limited to a single viewing window in a possible scenario all twelve windows can change twelve at a time for a certain list to show the first twelve channels then one scroll button click 903A displays the next twelve channels on the list in the viewing windows. Again, the lists really enable a lot of various content to be programmed and easily viewed.

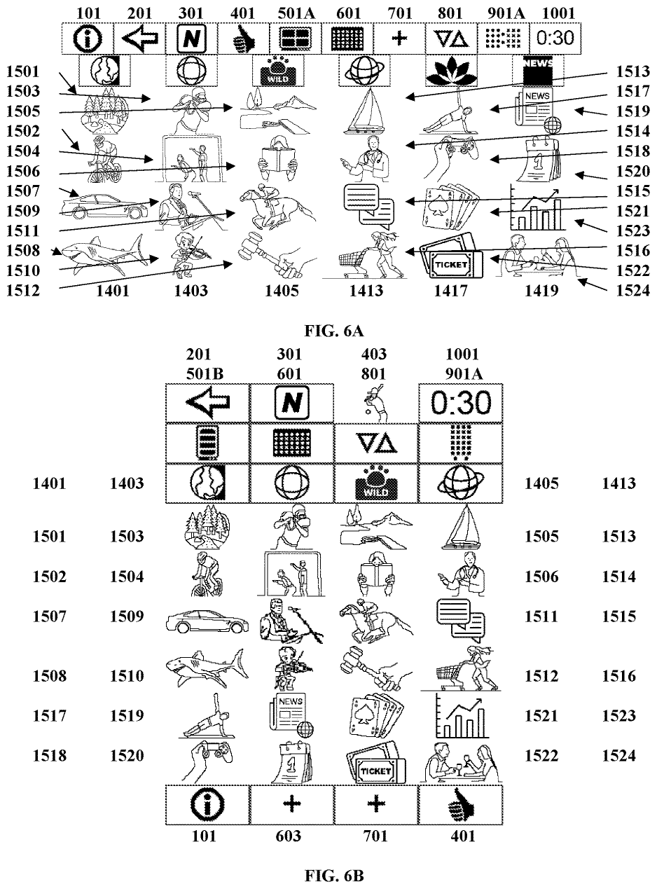

FIG. 6A is another embodiment of the invention wherein the twenty-four viewing windows split screen is on from button 105A in FIG. 2A. The main controls bar is on with the control bar on the top of the screen. Again, the control bar can easily be moved to the bottom of the screen. Similar to FIG. 5B there are only six channel identifier buttons in order to maximize the viewing window area. The channel identifier buttons are for each row of the viewing windows. There is a button not shown herein which changes the row the channel identifier buttons correspond to. These buttons work as follows. For row one viewing windows a button 1401 for a viewing window 1501, a button 1403 for a viewing window 1503, a button 1405 for a viewing window 1505, a button 1413 for a viewing window 1513, a button 1417 for a viewing window 1517, and a button 1419 for a viewing window 1519. For row two viewing windows a button 1401 for a viewing window 1502, a button 1403 for a viewing window 1504, a button 1405 for a viewing window 1506, a button 1413 for a viewing window 1514, a button 1417 for a viewing window 1518, and a button 1419 for a viewing window 1520. For row three viewing windows a button 1401 for a viewing window 1507, a button 1403 for a viewing window 1509, a button 1405 for a viewing window 1511, a button 1413 for a viewing window 1515, a button 1417 for a viewing window 1521, and a button 1419 for a viewing window 1523. For row four viewing windows a button 1401 for a viewing window 1508, a button 1403 for a viewing window 1510, a button 1405 for a viewing window 1512, a button 1413 for a viewing window 1516, a button 1417 for a viewing window 1522, and a button 1419 for a viewing window 1524. The main benefit here is the ability to have many viewing windows open at one time. Some of the other interesting viewing options shown herein but not limited to include an exercise channel, a newspaper viewing window, a telemedicine with a doctor viewing window, a video games window, a calendar or scheduling window, a chat or messaging window, a games or betting window, a stock market charts or financial monitoring windows or graphical dashboard windows, a shopping window, a tickets window, and a dating window. There are a plurality of options to populate the windows with all forms of multimedia content. There may even be viewing windows for something other than multimedia. Furthermore, the gambling and betting viewing window is interesting because you could have multiple sports or races viewing windows with multiple betting viewing windows. Another interesting application may be multiple graphical dashboards viewing windows for a plurality of different types of monitoring. Another is multiple shopping windows where you may have your favorite online stores saved as different window channels, another is the tickets which you can buy virtual passes to view online streaming of Broadway plays, concerts, events, comedians, DJs, nightclubs, etc. Also possible but not shown herein is the ability to click directly on the viewing window to purchase a product in the episode being viewed. This would be a great benefit for product placement campaigns. Also not shown are buttons for ordering food delivery. There are so many great ways to program viewing windows with the control buttons and viewing windows described herein.

FIG. 6B is similar to FIG. 6A but optimized for the vertical display screen orientation. Again element 403 can display the program image or media content for the current channel. This is not available on the main controls screen in the horizontal orientation of FIG. 6A because there is space for two extra slots in the vertical orientation. Also, the previous channel 701 and program image or media content for element 603 is not programmed with a channel so the channel identifier is a plus sign meaning add a channel here. Furthermore, there is only space for four channel identifiers to maximize the space for the viewing windows. Similar to the horizontal orientation of FIG. 6A there is a button not shown herein which changes the row the channel identifier buttons correspond to. These buttons work as follows. For row one viewing windows a button 1401 for a viewing window 1501, a button 1403 for a viewing window 1503, a button 1405 for a viewing window 1505, and a button 1413 for a viewing window 1513. For row two viewing windows a button 1401 for a viewing window 1502, a button 1403 for a viewing window 1504, a button 1405 for a viewing window 1506, and a button 1413 for a viewing window 1514. For row three viewing windows a button 1401 for a viewing window 1507, a button 1403 for a viewing window 1509, a button 1405 for a viewing window 1511, and a button 1413 for a viewing window 1515. For row four viewing windows a button 1401 for a viewing window 1508, a button 1403 for a viewing window 1510, a button 1405 for a viewing window 1512, and a button 1413 for a viewing window 1516. For row five viewing windows a button 1401 for a viewing window 1517, a button 1403 for a viewing window 1519, a button 1405 for a viewing window 1521, and a button 1413 for a viewing window 1523. For row six viewing windows a button 1401 for a viewing window 1518, a button 1403 for a viewing window 1520, a button 1405 for a viewing window 1522, and a button 1413 for a viewing window 1524. The main reason the viewing windows are organized as such is to ensure consistent switching when changing the split screens. Viewing window one needs to always be the top left and the viewing window does not need to reload when adding more windows down and to the right. The current window simply scales down to accommodate more windows. Also, there may be a case where more than twenty-four windows are needed not shown herein. This is why maintaining the two-by-two configuration is important with the top left, bottom left, top right, bottom right configuration. As more windows are added, blocks of two-by-two windows work best to maintain the best viewing experience. This does not the cases where obscure window shapes and sizes may be needed where special arrangements of viewing windows may be used not shown herein. Also, when going from twelve to twenty-four windows the next row is a vertical line of viewing windows for thirteen, fourteen, fifteen, and sixteen. After which the two-by-two blocks can be added. Again, this ensures consistency when switching between the different split screen orientations in both the horizontal and vertical orientations some of which are shown herein.

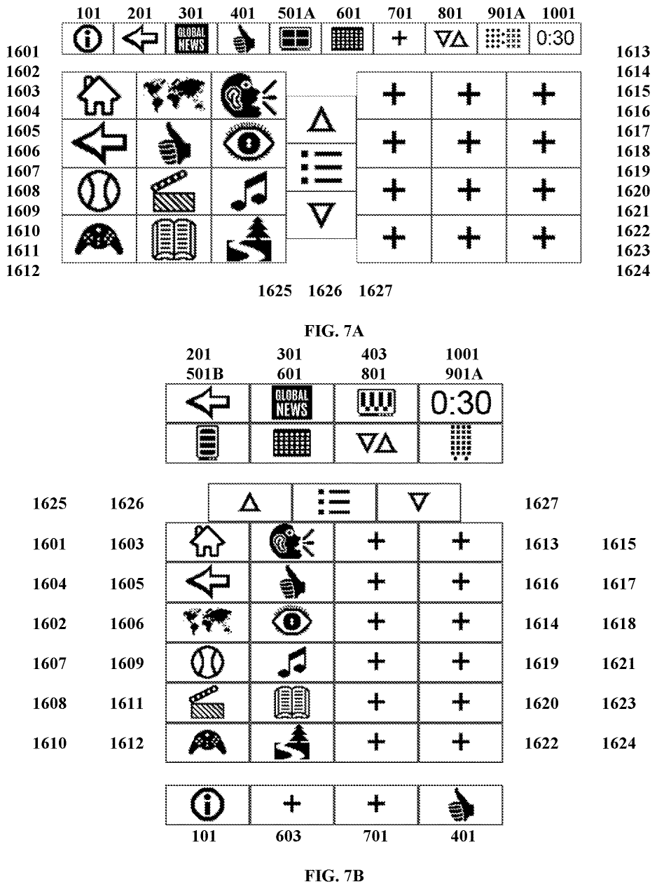

FIG. 7A is another embodiment of the invention for the list selector buttons. A button 1601, 1602, 1603, 1604, 1605, 1606, 1607, 1608, 1609, 1610, 1611, and 1612 are some of the examples of preprogrammed channel lists. The lists feature of this invention is very significant because it enables the user to switch between any type of multimedia content. The home list button 1601 is for a standard channel lineup provided such as with a cable tv package. The map button 1602 could be for lists such as global stations or something related to driving directions like maps and could be broadcasts of dash cams. The face button 1603 represents channels related to contacts such as a list of video conferencing your friends or business connections or any other conceivable list of human contacts who may be broadcasting themselves. The previous channels list button 1604 populates automatically as new channels are chosen and the previous channels are added to the list as the history of your past channels. The favorites list button 1605 represents favorite channels and can be customized to the users tastes. This could include any type of media content conceivable such as channel one is the daily newspaper, channel two is the morning news video broadcast, channel three is the morning news radio broadcast, channel four is the doctor's office telemedicine channel, channel five is the local high school sports team's livestream, channel six is the local concert venue's livestream, channel seven is your spouse's livestream, channel eight is the school secretary livestream, etc. Herein it is conceivable any channel could be added including movie stations, reading or books stations, audio only radio stations, even shopping so a window selector pulls up a window for your favorite online store, another channel could be for your email messages. The possibilities are endless here and this is why the optimized use case is for live linear television but any conceivable content viewed on a display screen window is conceivable and likely possible although some of these have not been fully developed yet. The viewing button 1606 represents travel like the map button 1602. Other possibilities include seeing what your friends are doing or see what's going on near you. The sports list 1607 can be channels of standard sports stations found on cable and satellite packages today; however, with streaming video the possibilities are endless because it is conceivable that every park, field, or gym could have a livestream for viewers to tune in to. Maybe there is a channel to watch neighbors playing tennis or to check if the local pool has a lane open for me to swim, etc. Again, as livestreaming becomes more ubiquitous the possibilities are endless. The movie list 1608 could be for on demand movies like is common with streaming services today. Movie lists could be curated to select an individual movie as a channel or an entire movie streaming service could be a channel which would open the streaming service app in a viewing window. Also, maybe a local movie theater has a livestream of their movies. The music list 1609 can be for music video channels. Also, there could be audio only channels like radio or podcasts. Maybe celebrity DJs could recommend their own music lists to share. Another exciting development in the future is the ability to have every concert venue livestreaming or at least on demand for their performances. This could even be expanded to being able to watch a play at a theatre in another country or a musical at the local high school. Again, these icons are not limiting and the possibilities here are endless. The video game list 1610 also has numerous possibilities. For example, it is common today to have millions of viewers for a celebrity video gamer and each gamer could be an individual channel on a list. Another possibility is to select individual games which are playable remotely because soon cloud computing will make the video game console obsolete. An entire video arcade will be in the cloud and a connected screen will interface to video game console in the cloud with any game desirable. There will still be a demand for customized tactile controllers with joysticks and physical buttons even after disks, cartridges, hard drives, and consoles are obsolete. The book list 1611 is for a viewing window to display reading material such as newspapers, magazines, books, social media posts, headlines, etc. Also written words could be converted to audio using text to speech technology in order to listen to what is written just like a book on tape and with text to image technology now becoming possible a book can actually be turned into a movie using AI and deep fake technology. One scenario may be to read the newspaper in one viewing window and listen to the business radio of the opening of the stock market in another viewing window. The art list 1612 could be for channels which display an image of a famous painting or it could be a slide show of artworks set to music. Art can be any appealing image such as paintings, scenery, photography, or maybe images of animals like screensavers or desktop backgrounds common in computers today. A button 1613, 1614, 1615, 1616, 1617, 1618, 1919, 1620, 1621, 1622, 1623, and 1624 are shown with plus signs indicating there are more possible customized channels lists. The icon could be uploaded and could represent different user profiles. The channel lists selector screen has a plurality of possibilities and is not limited to the twelve lists shown herein. Furthermore, an interesting use case in the four viewing window split screen could be video chatting with a friend, watching a baseball game, watching a concert, and playing a videogame all at the same time and having the ability to easily change the channel of any of these and add or remove any number of windows of friends or other content windows. A button 1625 is for moving to the next twelve channels on the list or next twelve lists. A button 1626 is for opening the list selector page shown herein or staying on one of the lists already selected. A button 1627 is for moving to the previous twelve channels on the list or previous twelve lists.

FIG. 7B has all the same functions of FIG. 7A but optimized for the vertical orientation. Buttons 1625, 1626, and 1627 be either on the top or the bottom of the list selector buttons.

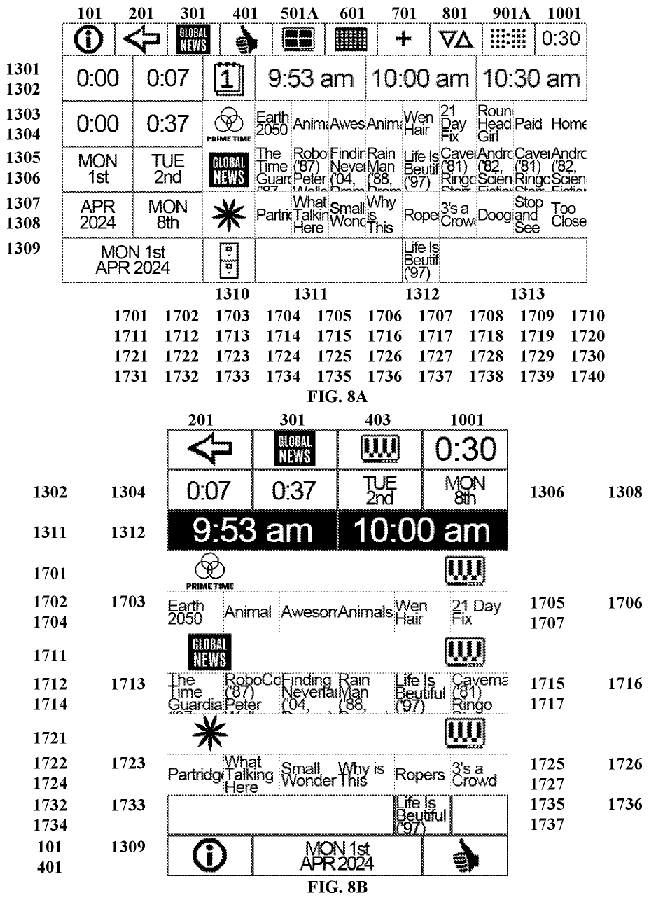

FIG. 8A is another embodiment of the same invention wherein there are many buttons for the electronic program guide EPG. The EPG is a very common way to navigate a channel lineup which already has a set playlist of programs showing at specific time slots. A button 1301 is for going back thirty minutes or in this case it is displaying zero because the EPG is already at the current time. Another possibility would be to be able to go back in time using for example some sort of cloud DVR wherein past content that occurred could be recalled by going back in time. A button 1302 is for going ahead thirty minutes or in this case it is displaying seven minutes because the current time is already 9:53 am. A button 1303 is for going back one hour or in this case zero because the EPG is at the current time. A button 1304 is for going ahead one hour or here it is displaying thirty-seven minutes because the current time is 9:52 am. A button 1305 is for going back one day and it is displaying the current day. A button 1306 is for going ahead one day. A button 1307 is for going back one week but since the EPG is in the present week it is displaying the month and year. A button 1308 is for going ahead one week. A button 1309 is for returning to the current time if the EPG gets ahead or behind the present. It is displaying the current date. A button 1310 is the calendar to toggles the side time changer controls on or off. These time changer controls could also be on the right side not shown herein. A button 1311 is the same as 1301 for going back thirty minutes and it displays the current time. A button 1312 is the same as 1302 for going ahead thirty minutes and displays the next thirty-minute time slot. A button 1313 is the same as 1303 for going ahead one hour and displays the time for two time slots ahead. A button 1701 is a channel selector button for the next channel in the list. A button 1711 is a channel selector for current channel and is the same as 301. A button 1721 is a channel selector for previous channel on the list. A button 1702, 1703, 1704, 1705, 1706, 1707, 1708, 1709, and 1710 are for the EPG time slots of the next channel on the list. When a time slot button is selected the EPG will save the time slot in storage. It is possible that when a saved future time slot reaches the current time the viewing window will automatically open to display the channel programmed. If a program extends longer into the future than some of the buttons will not be shown. For example, only button 1702 is shown if the program is over an hour and a half. A button 1712, 1713, 1714, 1715, 1716, 1717, 1718, 1719, and 1720 are for the EPG time slots of the current channel on the list. A button 1722, 1723, 1724, 1725, 1726, 1727, 1728, 1729, and 1730 are for the EPG time slots of the previous channel on the list. A button 1731 opens the saved time slots screen. A button 1732, 1733, 1734, 1735, 1736, 1737, 1738, 1739, and 1740 are for the saved time slots of the current channel on the list. As shown herein button 1736 has been saved with the program from the current channel for the time of 10:10 am to 10:20 am. When 10:10 is reached this channel will open in the viewing window. Another possibility not shown herein is the ability of the user to enter custom text and time slots for a channel. This way an appointment can be scheduled so a viewing will open at the scheduled time. For example, the user schedules their email viewing window to open every weekday at 8:00 am or they schedule their favorite music to open in a viewing window every Friday at 5:00 pm. Another interesting application could be to have multiple program guides for multiple users to select from a friend's guide or add an episode to your friends guide to watch together and video chat in another window while doing so. Another button not shown herein is the answer call button which can be selected into one of the viewing windows to receive a voice or video call.

FIG. 8B is similar to FIG. 8A but for the vertical orientation. Not shown are the buttons of 1301, 1303, 1305, and 1307 which occupy the same space as buttons 1302, 1304, 1306, and 1308. Button 1311 turns on the buttons to go back in time and button 1312 turns on the buttons to go ahead in time which is shown herein.

What is claimed is:

1. A system for managing multimedia content, comprising:
a plurality of control buttons and a plurality of viewing windows arranged in a grid;
wherein the horizontal orientation control buttons and the vertical orientation control buttons maintain a consistent position;
wherein there are main controls;
wherein there is an information button;
wherein there is a current channel button;
wherein there is a current channel viewing window;
wherein there is a calendar button;
wherein there is a previous channel button;
wherein there is a previous channel viewing window;
wherein there is a list selector button;
wherein there is an account button;
wherein there are previous channels controls;
and, the previous channels button maintains its position in the grid;
wherein there are favorite channels controls;
and, the favorite channels button maintains its position in the grid;
wherein there are split screen controls;
and, the split screen button maintains its position in the grid;
wherein there are channel scroller controls;
and, the channel scroller button maintains its position in the grid.

2. A system for managing multimedia content, comprising:
a plurality of control buttons and a plurality of viewing windows arranged in a grid;
wherein the horizontal orientation control buttons and the vertical orientation control buttons maintain a consistent position;
wherein there are channel scroller buttons;
and, wherein the current channel viewing window can be scrolled;
and, wherein the previous channel viewing window can be scrolled;
and, wherein there are a plurality of viewing windows which can be scrolled;
and, wherein the previous channels list can be scrolled;
and, wherein the favorites channels list can be scrolled;
and, wherein there are a plurality of channels lists which can be scrolled.

3. A system for managing multimedia content, comprising:
a plurality of control buttons and a plurality of viewing windows arranged in a grid;
wherein the horizontal orientation control buttons and the vertical orientation control buttons maintain a consistent position;
wherein there are a plurality of programmable channel identifier buttons;
wherein there are a plurality of programmable channel lists;
wherein there are a plurality of programmable electronic program guide buttons;
wherein there are a plurality of programmable viewing windows;
wherein the plurality of programmable viewing windows can be resized.
